(19) United States
(12) Patent Application Publication
(10) Pub. No.: US 2008/0040070 A1
(43) Pub. Date: Feb. 14, 2008

(54) Position Indicator for a Blowout Preventer

(75) Inventor: Perry Lee McClanahan, Willis, TX (US)

Correspondence Address: TIM COOK, P.O. BOX 10107, LIBERTY, TX, 77575, US

(73) Assignee: VARCO I/P, INC., Houston, TX (US)

(21) Appl. No.: 11/463,943

(22) Filed: Aug. 11, 2006

(51) Int. Cl. G01B 21/02

(52) U.S. Cl. 702/158; 356/3; 356/4.07; 356/4.09; 356/614; 356/625; 356/634; 702/127; 702/155

(57) ABSTRACT

At least one self-powered light source is mounted on the tail rod of a BOP to provide an indication of the position of the ram of the BOP. The light source moves back and forth with the ram actuating piston of the BOP. Opposite the light source is a light-receiving lens. The lens is coupled by optical fiber to a optical to electrical converter. As the BOP is actuated, the tail rod moves, thereby moving the light source to a position adjacent a different lens. The lens which is now positioned adjacent the light source sends a light signal to its respective converter, thereby indicating the position of the tail rod and thus to ram of the BOP.

### FIELD OF THE INVENTION

The present invention relates generally to the field of instrumentation for blowout preventers, and, more particularly, to a position indicator for a ram of a blowout preventer, wherein the sensor for the position indicator requires no electrical or magnetic power.

### BACKGROUND OF THE INVENTION

The use of blowout preventers (BOPs) in oil and gas fields is well known. A blowout preventer generally includes a housing with a bore extending through the housing. Opposed chambers extend laterally of the bore in the housing and communicate with the bore. Rams are positioned in the chambers and the rams are connected to rods that are supported for moving the rams inwardly into the bore to close off the bore. This action divides the bore into a zone above the rams and a zone below the rams. The force for moving the rams into the bore is commonly provided by respective hydraulically operated pistons coupled to the rods, with each piston enclosed within its respective operating cylinder. The rods also serve to retract outwardly from the bore to open the bore. In many BOPs, tail rods extend from the pistons outwardly of the operating cylinder of the pistons.

Various types of rams may be employed such as those which engage circumferentially around a tubular member extending through the BOP, such as for example coiled tubing, drill pipe, production pipe, or the like. The term “tubing” used herein refers to any of these types of tubular member. The BOP ram may provide for sealing engagement with the tubular member, while other types of BOP are provided with cutting surfaces for shearing the tubular member which extends through the bore of the blowout preventer.

Among other uses, BOPs are commonly used in oil and gas exploration and production systems as a means of holding the tubular member and isolating the well bore pressure during a variety of conditions, including emergencies. The configuration of the BOP rams and side port facility allow well-control operations to be conducted under a variety of conditions.

Newer blowout preventers include four sets of rams, which may be referred to herein as a “Quad BOP”. The system comprises a set of four stacked elements, each with a different function. Blind rams are shut when there is no tubing extending through the body of the BOP. Shear rams are designed to close on and cut through the tubing. Slip rams close on and hold the tubing, ideally without damaging the surface of the tubing member. Finally, pipe rams seal around the tubing when it is in place.

Regardless of which type of BOP ram is involved, knowledge of the parameters of the conditions of the well at the blowout preventer is important to maintaining proper operation of the well. For example, it is important to know whether a ram is open, shut, or in an intermediate position. If an operator knows the parameters of the conditions of the well at the BOP, he can control the well so that safe conditions are maintained in ordinary circumstances of operation. When an unsafe condition is detected that cannot be controlled, this knowledge enables the operator to shut down the well, either manually or automatically. In addition to position indication, for example, pressure transducers and temperature transducers are used at the blowout preventer to develop signals indicative of these respective conditions.

These and other signals are typically presented as control signals on a control console manned by a well operator. The well operator controls the operation of the well by controlling the rotating speed on the drill pipe, controlling the downward pressure on the drill bit, regulating the circulation pumps for the drilling fluid for a drilling operation, and adjusting the extent that the annulus is opened or closed by actuating the hydraulically actuated pistons connected to the reciprocating rams.

Without a position indicator, however, it is not possible to know precisely the location of the rams, even though the operator might be controlling them, since the rams are enclosed within the body of the BOP. Certain semaphore types of indicators, mechanically coupled to the tail rods, are well known in the art but are of no use to a well operator who is not within sight of the BOP. In such a circumstance, the well operator must rely on secondary measurements, such as well flow, to estimate the positions of the rams. Well flow, however, is affected by more than how large the ram gap is. Thus, there has been a need for an improved measure of the position of a ram which can be provided to a well operator positioned away from the well head.

One device used in the past to develop a signal indicative of the relative position of component parts located within an enclosed housing (not necessarily in a blowout preventer housing) is a potentiometric transducer. Such a device uses one or more sensors that are subject to wear and inaccuracies in the presence of a harsh environment. Also, a loss of power often causes distorted readings because these devices operate incrementally, adding or subtracting values related to specific turns or segments of wire to a previous value. Furthermore, BOP's are commonly located in areas containing high-concentrations of volatile gases, and thus the use of electrical power is prohibited, making these types of devices impractical for such an environment.

Young et al., in U.S. Pat. No. 5,407,172, taught a position instrumented blowout preventer. In the BOP of Young et al., a ram was enclosed within an enclosure so that the piston driving the ram was placed parallel to a stationary magnetizable waveguide tube. A transverse ring-like magnet assembly surrounded the tube and was attached to a carrier that was attached to the tail rod of the piston. The magnet assembly longitudinally magnetized an area of the tube where it was located. A wire running through the tube was periodically interrogated with an electrical current pulse, which produced a toroidal magnetic field about the wire. When the toroidal field intersected with the longitudinally magnetized area, a magnetostrictive acoustical return pulse was reflected back up the tube for detection by a transducer located outside of the enclosure. The time that the acoustical pulse traveled from the magnetic field intersection compared to the timing of the electrical pulse on the wire was a measure of distance since the pulse time essentially travels at the speed of light. Thus, the position of the ram was determined. From the position information from successive pulses, ram velocity and acceleration information could be developed.

However, as with other sensors previously described, the system of Young et al. requires electrical power at the well head, typically within a volume of high concentrations of volatile gases. Thus, there remains a need for a position indication sensor and system to positively indicate of the positions of the rams of a BOP without the need for electrical power. The present invention is directed to filling this need in the art.

### SUMMARY OF THE INVENTION

The present invention solves these and other drawbacks in the art by providing self-powered light sources mounted on the tail rods of a BOP. The light sources move back and forth with the pistons of the BOP. Opposite each light source is a set of light-receiving lenses. Each lens is coupled by optical fiber to an optical-to-electrical converter. Thus, the lens which is positioned adjacent the light source sends a light signal to its respective light converter. As the BOP is actuated, the tail rod moves, thereby moving the light source to a position adjacent a different lens. The lens which is now positioned adjacent the light source sends a light signal to its respective sensor, thereby indicating the position of the tail rod and thus to ram of the BOP.

Self-powered lighting is a generic term describing devices that emit light continuously without an external power source. Early self-powered lighting used radium paint, which posed a radiation threat to workers who handled it as well as users of the devices incorporating it. More recently, self-powered lighting, such as that employed in the present invention, has utilized tritium. Tritium lighting is made using glass tubes with a phosphor layer in them and tritium (a hydrogen isotope—H₃) gas inside the tube. Such a tube is known as a “gaseous tritium light source” (GTLS). The tritium in a gaseous tritium light source undergoes beta decay, releasing electrons which cause the phosphor layer to fluoresce. Typical GTLSs made today from a variety of sources have an expected life span of approximately 20 years, well beyond the expected life span of the BOP in which the light source is mounted.

Thus, the position indicator of this invention eliminates the need for an electrical power source, and yet provides a positive indication of the position of the BOP rams. The light source is protected within the housing of the BOP, and is thus not subjected to damaging contact. No parts abrade against each other, thereby eliminating a source of maintenance failures of previously used mechanical position indicators.

Another aspect of the present invention provides a distinctive means of indicating the position of a BOP ram. In a first embodiment, one light indicator is illuminated when the BOP ram is in an open position, and another indicator is illuminated when the BOP ram is in a shut position, with the colors of the light indicators differing to assist the operator in distinguishing between open and shut. In a further aspect of this invention, an intermediate position indicator is provided, describing the BOP ram in an unsafe, mid-position.

In still another aspect of the invention, light is received from the tritium source and transmitted over fiber optic cable to an optical to electrical converter. The converted signal is then provided to a processor, which generates an audible indication of BOP ram position. The audible signal may, in fact, be computer generated voice so that a voice indicates to the operator the position of the BOP ram.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a schematic diagram in partial section with a position indication system of this invention installed on a BOP ram tail rod.

FIG. 2 is a detail schematic diagram is partial section of a dual light source configuration of this invention.

FIG. 3 is a schematic diagram of an audible indicator for this invention.

### DETAILED DESCRIPTION OF A PREFERRED EMBODIMENT

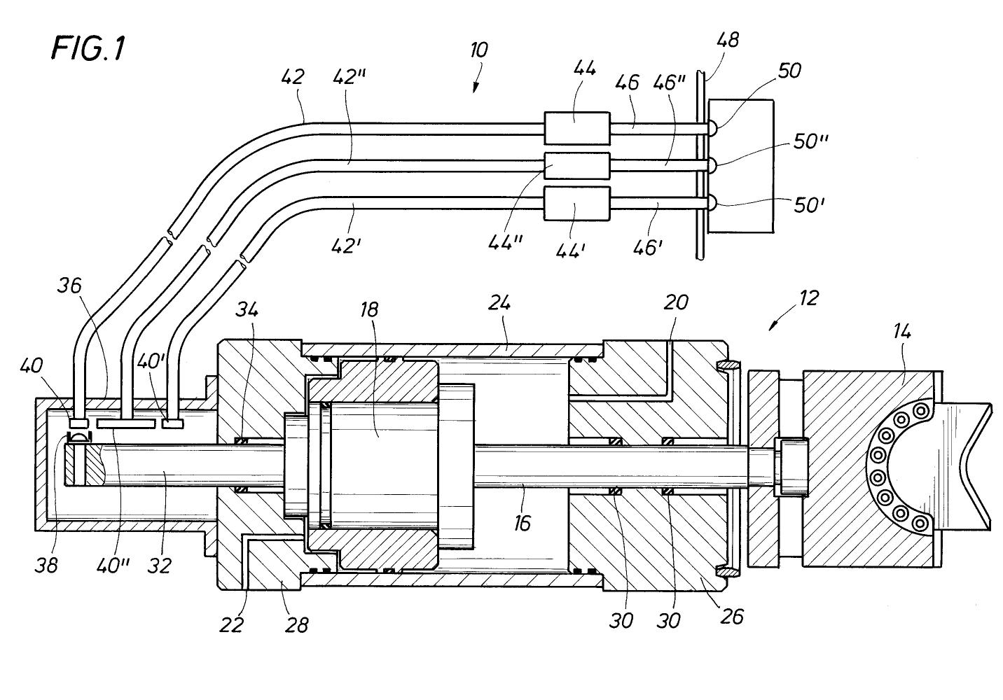

FIG. 1 depicts a position indication system 10 mounted in functional arrangement with a BOP ram element 12. It should be understood that a complementary ram element (not shown) is positioned opposite the element 12 for actuation into the bore of a BOP. The element primarily comprises a ram 14 coupled to a rod 16, which is moved back and forth by a piston 18 under hydraulic pressure. An open port 20 provides hydraulic fluid under pressure to move the piston 18 (and therefore the ram 14) to the left, opening the ram. A close port 22 provides hydraulic fluid under pressure for the opposite motion, moving the piston to the right to shut the ram.

The piston 18 is retained within a cylinder 24, which is closed off at one end by an end cap 26 and at the other end by an end cap 28. The rod 16 penetrates the end cap 26 and is sealed with O-rings 30. Also, a tail rod 32 is coupled to and extends from the piston 18, so that the tail rod 32 moves reciprocally with the piston. The tail rod 32 penetrates the end cap 28 and is sealed with an O-ring 34.

The tail rod extends into a tail rod housing 36, which is long enough to accommodate the tail rod when the ram 14 is fully withdrawn, as illustrated in FIG. 1. At least one self-powered light 38 is installed on the tail rod 32 so that its light is selectively directed. At least one light receiver 40 is installed within the housing 36 so that, when the ram 14 is in a selected position, the light receiver 40 is positioned directly opposite the self-powered light 38. An optical fiber or fiber optic cable 42 carries the light received by the light receiver 40 from the light 38 to an optical-to-electrical converter 44. The optical-to-electrical converter 44 develops an electrical signal, which is transmitted over an electrical conductor 46 into a control panel 48.

The control panel 48 preferably includes at least one indicator light 50. With the arrangement illustrated in FIG. 1, with the ram 14 in the open position as shown, the self-powered light source 38 is positioned directly opposite the light receiver 40 and the light 50 will therefore be illuminated. Notice that no electrical power is required in the vicinity of the BOP, since the optical fiber 42 carries the light signal from the self-powered light 38 to a location remote from the ram element 12.

As previously described, the position indicator of this invention preferably includes at least one self-powered light source 38 and at least one light receiver 40. However, in a preferred embodiment, a second light receiver 40′ is provided. In this way, the light source 38 is positioned opposite the light receiver 40 when the ram is at full stroke in the open position, and opposite the light receiver 40′ when the ram is at full stroke in the closed position. In this preferred embodiment, the light receiver 40′ is coupled to an optical fiber 42′, which conducts light to an optical-to-electrical converter 44′. The optical to electrical converter 44′ develops an electrical signal, which is conducted over an electrical conductor 46′ to the control panel 48 to illuminate a light indicator 50′.

Preferably, the indicator light 50 is a different color than the indicator light 50′, so that an operator at the control panel 48 can easily determine by the color of the indicator light whether the BOP is open or shut. However, there are occasions when the operator needs to know that the BOP is between the open and shut positions. In this event, yet another light receiver 40″ is provided. The light receiver 40″ preferably extends from the vicinity close to the receiver 40 to the vicinity close to the receiver 40′. The light receiver 40″ receives light energy from the light 38 whenever the ram leaves the open position and before is reaches the closed position. An optical fiber or fiber optic cable 42″ conducts the light thus received to an optical-to-electrical converter 44″ which develops an electrical signal which is conducted over an electrical conductor 46″ to the control panel 48. This electrical signal illuminates an indicator light 50″, which is preferably of a color to indicate an unsafe condition, for example red.

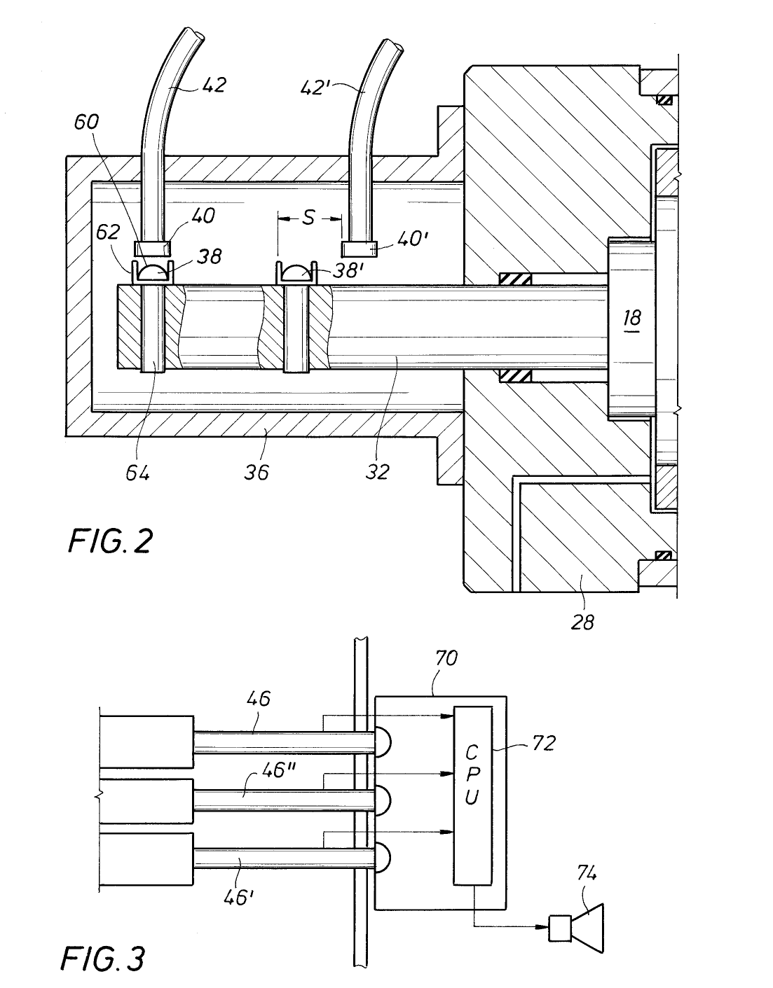

Referring now to FIG. 2, a dual source configuration of this invention is depicted. In normal circumstances, a single self-powered light source is adequate since the ram of the BOP provides sufficient stroke length to move the light source from one light receiver to another light receiver. However, if the stroke is very small (i.e. small coil tubing applications, etc.), there may be insufficient lateral movement of the light source to adequately discriminate open from shut positions. In this event, for a small stroke S (FIG. 2), a second, self-powered light source 38 is provided. That way, the light source 38 of positioned next to the light receiver 40 if the ram is in the full open position, while a source 38′ is positioned next to a light receiver 40′ if the ram is in the shut position, with the tail rod moving only the distance S.

FIG. 2 also depicts additional details of the configuration of the self-powered light sources 38 and 38′. The light is preferably somewhat collumated by a light collar 62. An energy source, such as a tritium wand 64 emits decay energy which is received by a flourescing lens 60, which develops the light energy for transmission over the appropriate optical fiber 42, 42′, or 42″. This feature of the invention directs light directly onto the receiver, and not out into the tailrod housing where it may be received by another receiver as noise.

Finally, FIG. 3 illustrates an additional feature of the invention is it relates to an audible indicator, in place of or preferably in addition to the light indicators previously described. Each of the electrical conductors 46, 46′, and 46″ provide an input into a control module 70 which includes central processing unit 72. The CPA 72 interprets the electrical signals over the input lines as digital signals. A light input from the receiver 40, and no input from the other receiver(s), is interpreted as indicating that the ram is shut, and an audible signal, including a voice generation signal, is provided by the CPU that that the ram is shut. Similarly, a light signal received by the receiver 40′ (and no other signals) indicates that the ram is shut, and an audible signal, such as a tone or a voice signal, indicates such by a speaker 74. If the ram is in an intermediate position for longer than a predetermined period of time, indicating an unsafe condition for the ram, a different signal is generated by the CPU, including an alarm signal or a voice signal telling the operator of the condition.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A position indicator for a ram element of a blowout preventer, the ram element including a tail rod within a tail rod housing, the position indicator comprising:
a. a self-powered light source mounted on the tail rod;
b. a first light receiver within the tail rod housing, positioned adjacent the light source when the ram element is in a first selected position;
c. a first optical fiber coupled to the first light receiver to conduct light received by the first light receiver from the light source;
d. a first optical-to-electrical converter coupled to the first optical fiber to convert light conducted by the first optical fiber into a first electrical signal;
e. a first electrical conductor coupled to the first optical-to-electrical converter to conduct the first electrical signal from the first optical-to-electrical converter; and
f. a first indicator to receive the first electrical signal from the first electrical conductor to develop an indication of a first position of the ram element.

2. The position indicator of claim 1, wherein the first indicator is a light of a first color.

3. The position indicator of claim 1, wherein the first indicator is a first audible signal.

4. The position indicator of claim 1, wherein the first indicator is a first computer generated voice signal.

5. The position indicator of claim 1, further comprising a second light receiver within the tail rod housing, positioned adjacent the light source when the ram element is in a second selected position.

6. The position indicator of claim 5, further comprising:
a. a second optical fiber coupled to the second light receiver to conduct light received by the second light receiver from the light source;
b. a second optical-to-electrical converter coupled to the second optical fiber to convert light conducted by the second optical fiber into a second electrical signal;
c. a second electrical conductor coupled to the second optical-to-electrical converter to conduct the second electrical signal from the second optical-to-electrical converter; and
d. a second indicator to receive the second electrical signal from the second electrical conductor to develop an indication of a second position of the ram element.

7. The position indicator of claim 6, wherein the second indicator is a light of a second color.

8. The position indicator of claim 6, wherein the second indicator is a second audible signal.

9. The position indicator of claim 6, wherein the second indicator is a second computer generated voice signal.

10. The position indicator of claim 5, further comprising a third light receiver within the tail rod housing, positioned adjacent the light source when the ram element is between the first and second selected positions.

11. The position indicator of claim 10, further comprising:
a. a third optical fiber coupled to the third light receiver to conduct light received by the third light receiver from the light source;
b. a third optical-to-electrical converter coupled to the third optical fiber to convert light conducted by the third optical fiber into a third electrical signal;
c. a third electrical conductor coupled to the third optical-to-electrical converter to conduct the third electrical signal from the third optical-to-electrical converter; and
d. a third indicator to receive the third electrical signal from the third electrical conductor to develop an indication that the ram element is between the first and second positions.

12. The position indicator of claim 11, wherein the third indicator is a light of a third color.

13. The position indicator of claim 11, wherein the third indicator is a third audible signal.

14. The position indicator of claim 11, wherein the third indicator is a third computer generated voice signal.

15. A position indicator for a ram element of a blowout preventer, the ram element including a tail rod within a tail rod housing, the position indicator comprising:
a. a first self-powered light source mounted on the tail rod;
b. a second self-powered light source mounted on the tail rod spaced apart from the first self-powered light source;
c. a first light receiver within the tail rod housing, positioned adjacent the first light source when the ram element is in a first selected position;
d. a second light receiver within the tail rod housing, positioned adjacent the second light source with the ram element is in a second selected position;
e. a first optical fiber coupled to the first light receiver to conduct light received by the first light receiver from the first light source;
f. a second optical fiber coupled to the second light receiver to conduct light received by the second light receiver from the second light source;
g. a first optical-to-electrical converter coupled to the first optical fiber to convert light conducted by the first optical fiber into a first electrical signal;
h. a second optical-to-electrical converter coupled to the second optical fiber to convert light conducted by the second optical fiber into a second electrical signal;
i. a first electrical conductor coupled to the first optical-to-electrical converter to conduct the first electrical signal from the first optical-to-electrical converter;
j. a second electrical conductor coupled to the second optical-to-electrical converter to conduct the second electrical signal from the second optical-to-electrical converter;
k. a first indicator to receive the first electrical signal from the first electrical conductor to develop an indication of a first position of the ram element; and
l. a second indicator to receive the second electrical signal from the second electrical conductor to develop an indication of a second position of the ram element.

16. The position indicator of claim 15, wherein the first indicator is a light of a first color and the second indicator is a light of a second color.

17. The position indicator of claim 1, wherein the first indicator is located on a control panel remote from the blowout preventer.

18. The position indicator of claim 15, wherein the first and second indicators are located on a control panel remote from the blowout preventer.
